(19) United States
(12) Patent Application Publication
(10) Pub. No.: US 2014/0170925 A1
(43) Pub. Date: Jun. 19, 2014

(54) METHOD FOR MANUFACTURING LIQUID CRYSTAL DISPLAY PANEL

(71) Applicant: ADVANCED OPTOELECTRONIC TECHNOLOGY, INC., Hsinchu Hsien (TW)

(72) Inventors: MING-TA TSAI, Hukou (TW); PO-MIN TU, Hsinchu (TW)

(73) Assignee: ADVANCED OPTOELECTRONIC TECHNOLOGY, INC., Hsinchu Hsien (TW)

(21) Appl. No.: 13/967,948

(22) Filed: Aug. 15, 2013

(30) Foreign Application Priority Data
Dec. 17, 2012 (CN) 2012105474467

(51) Int. Cl. G02F 1/1341

(52) U.S. Cl. CPC G02F 1/1341
USPC 445/25

(57) ABSTRACT

A method of manufacturing an LCD panel includes following steps: providing a first translucent panel, the first translucent panel including an upper surface and a lower surface opposite to the upper surface, a middle of the top surface depressed inwardly and thereby defining a recess; providing glue on the upper surface, and the glue being located outside of the recess, the glue capable of being solidified when irradiated by UV light; providing a second translucent panel which covers the upper surface of the first translucent panel; a room being cooperatively defined by the recess of the first translucent panel and the second translucent panel; filling the room with liquid crystal; and providing a UV LED light source which is moved around lateral sides of the first and second translucent panels to irradiate the glue, thereby solidifying the glue.

### BACKGROUND

1. Technical Field

The present disclosure relates to a method for manufacturing a liquid crystal display (LCD) panel, and more particularly to a method for manufacturing an LCD panel which will not cause the liquid crystal to have metamorphic problem during the curing of the silicone/resin of the LCD panel.

2.Description of Related Art

The traditional method for manufacturing a liquid crystal panel includes: pouring liquid crystal into a space between two pieces of glass; sealing lateral sides of the two pieces of glass to avoid the liquid crystal from flowing out by filling silicone or resin material in a gap between the two pieces of glass; putting the liquid crystal panel into a chamber, and then irradiating the silicone or resin material with UV (ultraviolet) light until the silicone or resin is cured.

However, in the process of irradiating the silicone or resin with the ultraviolet light, the ultraviolet light with a large range of wavelength and illumination can also affect the crystal liquid whereby the liquid crystal in the two pieces of glasses is prone to be metamorphic or deteriorated.

Therefore, a method for manufacturing LCD panel which is capable of overcoming the above described shortcomings is desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIGS. 1-3 show three steps of a method for manufacturing an LCD panel in accordance with an embodiment of the present disclosure respectively.

FIG. 4 is a cross-sectional view of FIG. 3, taken along a line IV-IV thereof.

FIGS. 5-6 show a fourth step to a fifth step of the method for manufacturing an LCD panel in accordance with the embodiment of the present disclosure respectively.

### DETAILED DESCRIPTION

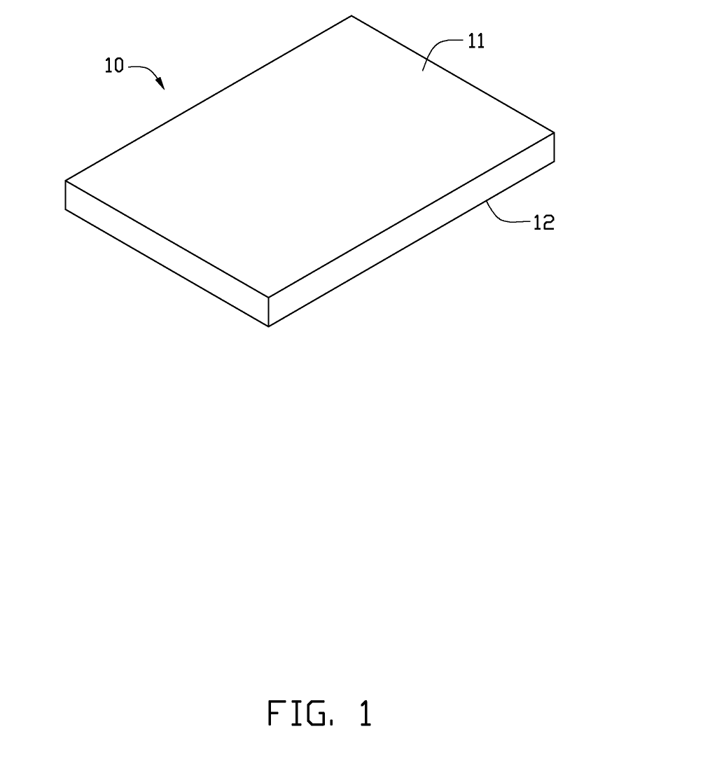

Referring to FIG. 1, a first translucent panel 10 is provided. In this embodiment, the first translucent panel 10 is made of glass. The first translucent panel 10 is rectangle in shape, and includes an upper surface 11 and a lower surface 12 opposite to the upper surface 11.

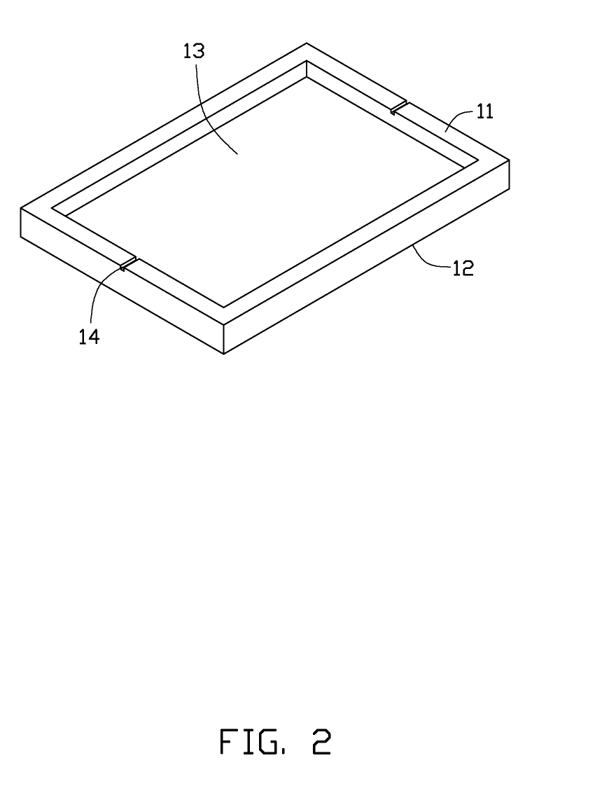

Referring to FIG. 2, a middle of the upper surface 11 of the first translucent panel 10 is depressed inwardly to define a recess 13. A pair of guiding grooves 14 are oppositely defined in the upper surface 11 of the first translucent panel 10 around the recess 13, wherein the recess 13 is communicated with an external environment of the first translucent panel 10 via the pair of guiding grooves 14. In this embodiment, the pair of guiding grooves 14 are located at two opposite lateral sides of the recess 13. A glue is provided on the upper surface 11 of the first translucent panel 10, and the glue is located outside of the recess 13. The glue can be solidified when irradiated by the ultraviolet (UV) light. In this embodiment, the glue can be UV-curable silicone or resin.

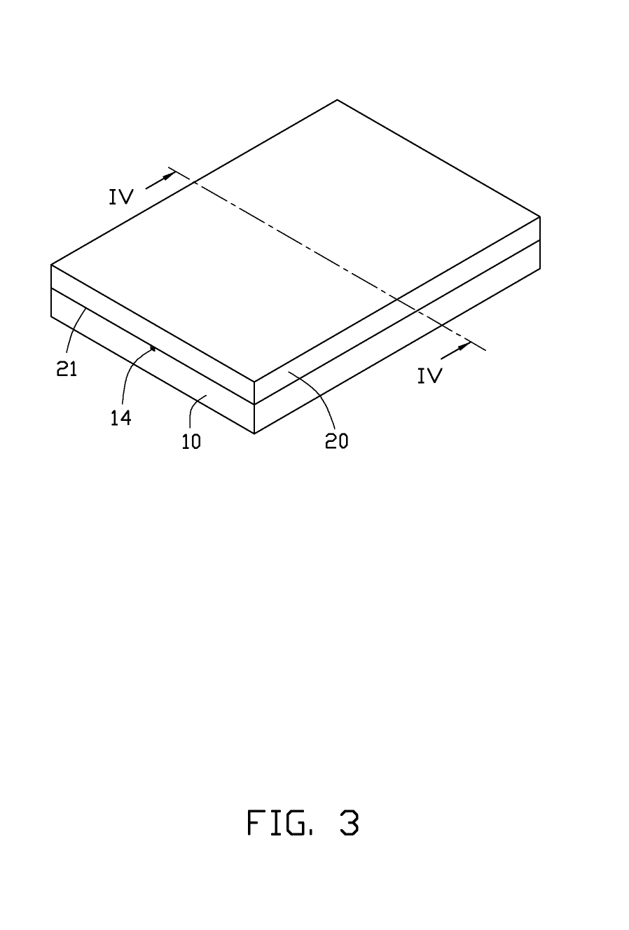

Referring to FIG. 3, a second translucent panel 20 is provided to cover the first translucent panel 10, and a bottom surface 21 of the second translucent panel 20 is attached with the upper surface 11 of the first translucent panel 10 via the glue. A lateral side of the first translucent panel 10 is coplanar with that of the second translucent panel 20. In this embodiment, all the lateral sides of the first translucent panel 10 are coplanar with corresponding lateral sides of the second translucent panel 20.

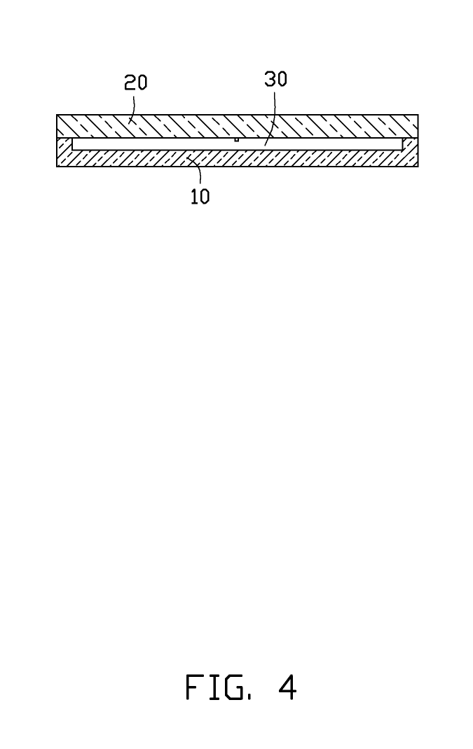

Referring to FIG. 4, a room 30 is cooperatively defined by the recess 13 of the first translucent panel 10 and the second translucent panel 20, and the room 30 is communicated with the external environment via the guiding grooves 14.

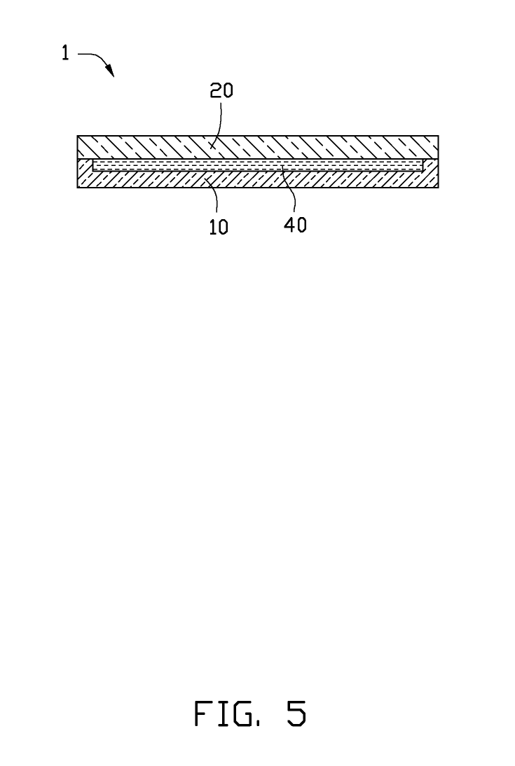

Referring to FIG. 5, the room 30 is filled with liquid crystal via one of the guiding grooves 14. The one guiding groove 14 is acted as a liquid crystal inlet, and the other guiding groove 14 is acted as an air outlet until the room 30 is full of the liquid crystal.

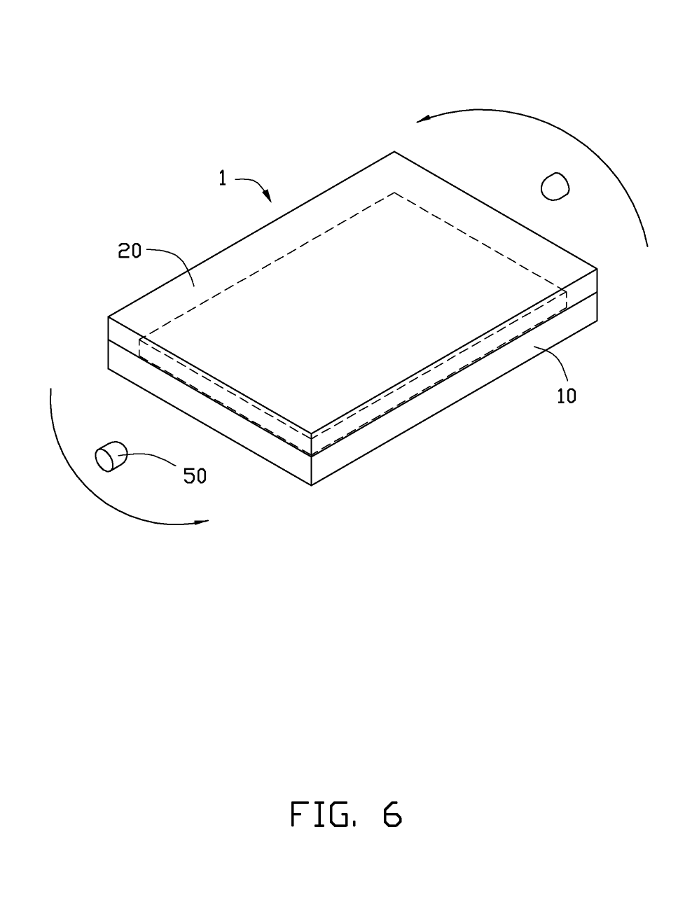

Referring to FIG. 6, the pair of guiding grooves 14 are sealed by the glue, and at least one ultraviolet LED light source 50 is provided at the lateral sides of the first translucent panel 10 and the second translucent panel 20; then the ultraviolet LED light source 50 is moved around the lateral sides of the first and second translucent panels 10, 20 to irradiate the glue, thereby solidifying/curing the glue. A liquid crystal display panel 1 is finished. For the ultraviolet LED light source 50 being a point light source which has a small range of wavelength (i.e., 360-380 nm) and illumination, the ultraviolet LED light source 50 can only irradiate the glue, thereby avoiding irradiating the liquid crystal; accordingly, the problem of metamorphosis and deterioration of the crystal liquid due to the radiation of the UV light to the glue is prevented by the present disclosure.

In use, for the wavelength range of the ultraviolet LED light source 50 being 360 nm to 380 nm, which is a narrow range of wavelength, light emitted from the ultraviolet LED light source 50 can all be used to solidify the glue, thereby improving the efficiency of utilization of the ultraviolet LED light, and avoiding waste of the energy of the ultraviolet LED light. Additionally, for the ultraviolet LED light source 50 being the point light source and having a small range of illumination, the ultraviolet LED light source 50 can be used to irradiate the glue only, thereby avoiding irradiating the liquid crystal to prevent the crystal liquid from being metamorphic or deteriorated. Furthermore, the ultraviolet LED light source 50 is moved around the lateral sides of the first and second translucent panels 10, 20 to irradiate and solidify the glue, thereby avoiding the use of a plurality of UV light sources which are UV light tubes; thus, the manufacturing cost of the liquid crystal display panel 1 can be lowered.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A method of manufacturing a liquid crystal display (LCD) panel comprising:
providing a first translucent panel, the first translucent panel comprising an upper surface and a lower surface opposite to the upper surface, a middle of the top surface of the first translucent panel defining a recess;
providing glue on the upper surface of the first translucent panel around the recess, and the glue being located outside of the recess, the glue capable of being solidified when irradiated by ultraviolet (UV) light;
providing a second translucent panel to cover the upper surface of the first translucent pane, the first and second translucent panels being attached to each other by the glue, a room being cooperatively defined by the recess of the first translucent panel and the second translucent panel;
filling the room with liquid crystal;
providing a UV LED light source which generates UV light having a range of wavelength of 360 nm to 380 nm to irradiate the glue, thereby solidifying the glue.

2. The method of manufacturing a liquid crystal display panel of claim 1, wherein the recess is communicated with external of the first translucent panel via a pair of guiding grooves, one guiding groove is acted as a liquid crystal inlet, and the other guiding groove is acted as an air outlet during the filling of the room with liquid crystal.

3. The method of manufacturing a liquid crystal display panel of claim 2, wherein the pair of guiding grooves are located two opposite sides of the recess, respectively.

4. The method of manufacturing a liquid crystal display panel of claim 3, wherein before the step of providing a UV LED light source, the pair of guiding grooves are sealed by the glue.

5. The method of manufacturing a liquid crystal display panel of claim 1, wherein the glue is UV-curable silicone or resin.

6. The method of manufacturing a liquid crystal display panel of claim 1, wherein when the UV LED light source irradiates the glue, the UV LED light source is moved around lateral sides of the first and second translucent panels.

7. A method of manufacturing a liquid crystal display (LCD) panel comprising following steps:
providing a first translucent panel, the first translucent panel comprising an upper surface and a lower surface opposite to the upper surface;
depressing a middle of the top surface of the first translucent panel inwardly and thereby defining a recess;
providing glue on the upper surface of the first translucent panel, and the glue being located outside of the recess, the glue capable of being solidified when irradiated by ultraviolet (UV) light;
providing a second translucent panel and covering the upper surface of the first translucent panel with the second translucent panel, the first and second translucent panels being attached with each other by the glue, a room being cooperatively defined by the recess of the first translucent panel and the second translucent panel;
filling the room with liquid crystal;
providing at least one UV LED light source, moving the at least one UV LED light source around lateral sides of the first and second translucent panels to irradiate the glue, thereby solidifying the glue.

8. The method of manufacturing a liquid crystal display panel of claim 7, wherein the recess is communicated with external environment of the first translucent panel via a pair of guiding grooves, one guiding groove is acted as a liquid crystal inlet, and the other guiding groove is acted as an air outlet during the filling of the room with liquid crystal.

9. The method of manufacturing a liquid crystal display panel of claim 8, wherein the pair of guiding grooves are located at opposite sides of the recess.

10. The method of manufacturing a liquid crystal display panel of claim 9, wherein before the step providing at least one UV LED light source, the pair of guiding grooves are sealed by the glue.

11. The method of manufacturing a liquid crystal display panel of claim 7, wherein the glue is UV-curable silicone or resin.

12. The method of manufacturing a liquid crystal display panel of claim 8, wherein the pair of guiding grooves are defined in the first translucent panel.

13. The method of manufacturing a liquid crystal display panel of claim 8, wherein the at least one UV LED light source generates a UV light having a wavelength range of 360 nm to 380 nm.
